(19) United States
(12) Patent Application Publication
(10) Pub. No.: US 2009/0172620 A1
(43) Pub. Date: Jul. 2, 2009

(54) TIMING ANALYZING APPARATUS, TIMING ANALYZING METHOD, AND COMPUTER-READABLE STORAGE MEDIUM ON WHICH TIMING ANALYZING PROGRAM IS RECORDED

(76) Inventor: Kenji Yoshida, Akishima-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/339,678

(22) Filed: Dec. 19, 2008

(30) Foreign Application Priority Data
Dec. 28, 2007 (JP) 2007-340314

(51) Int. Cl. G06F 17/50

(52) U.S. Cl. 716/6

(57) ABSTRACT

According to one embodiment, a timing analyzing apparatus comprises an instance list creating module configured to create instance lists for each path reports, an instance list report creating module configured to create an instance list report including the instance lists, a maximally appearing instance determining module configured to determine an instance which most frequently appears, a worst slack value determining module configured to determine a slack value which is worst as a worst slack value in an instance list including the maximally appearing instance, an ECO determining module configured to determine an ECO place and ECO value based on the maximally appearing instance and the worst slack value, and a deleting module configured to delete the instance list including the maximally appearing instance.

### CROSS-REFERENCE TO RELATED APPLICATIONS

This application is based upon and claims the benefit of priority from Japanese Patent Application No. 2007-340314, filed Dec. 28, 2007, the entire contents of which are incorporated herein by reference.

### BACKGROUND

1. Field

One embodiment of the invention relates to a timing analyzing apparatus, a timing analyzing method, and a timing analyzing program which analyze an operation timing of an integrated circuit in an EDA (Electronic Design Automation) environment and a computer-readable medium in which the timing analyzing program is stored.

2. Description of the Related Art

In an integrated circuit using the EDA environment, timing analysis of a logic circuit for a setup time or a hold time is important. The setup time is the minimum time for which a data signal must be held prior to a clock signal or the like. The hold time is the minimum time for which data signal must be held after the clock signal or the like is issued.

The timing analysis of this type is performed in each of a large number of modes (for example, a low-temperature operation mode, a high-temperature operation mode, a low-voltage operation mode, a high-voltage operation mode, an operation mode set in consideration of a fluctuation in process, and the like) and an analyzing mode (for example, a system mode, a scan mode, or the like). Since a large number of path reports are created accordingly, a designer to detect a place where an ECO (Engineering Change Order) is issued or inserted bears a heavy burden. For this reason, in a timing analyzing technique described in Jpn. PCT National Publication No. 2007-524891, these path reports are analyzed, and a setup violation or a hold violation is detected to realize automation of issuance and insertion of an ECO.

In a conventional timing analyzing technique, although a hold violation is detected to automatically issue and insert an ECO into the place, the place is immediately prior to an end point of a timing path. However, in an integrated circuit, logical circuits are complexly connected while being multiplexed and branched. When ECO is issued and inserted immediately prior to the end point, the number of places where the ECO is issued and inserted increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary circuit block diagram showing a configuration of a timing analyzing apparatus according to an embodiment of the present invention;

FIG. 2 is an exemplary view showing a path report;

FIG. 3 is an exemplary view showing an instance list;

FIGS. 4A and 4B are exemplary views showing instance list reports;

FIG. 5 is an exemplary view showing an ECO detection report;

FIG. 6 is an exemplary circuit diagram showing the path report shown in FIG. 2;

FIG. 7 is an exemplary timing chart of a data signal and a clock signal in the path report shown in FIG. 2;

FIG. 8 is an exemplary flow chart of a timing analyzing method according to an embodiment of the present invention;

FIG. 9 is an exemplary view showing a configuration of a timing analyzing program according to an embodiment of the present invention together with a storage medium;

FIG. 10 is an exemplary view showing a hardware configuration of a computer to execute a program stored in a storage medium; and

FIG. 11A and 11B are exemplary circuit diagrams showing a configuration of an integrated circuit.

### DETAILED DESCRIPTION

Various embodiments according to the invention will be described hereinafter with reference to the accompanying drawings. In general, according to one embodiment of the invention,

According to one embodiment, a timing analyzing apparatus comprises an instance list creating module configured to create instance lists for each path reports, an instance list report creating module configured to create an instance list report including the instance lists, a maximally appearing instance determining module configured to determine an instance which most frequently appears, a worst slack value determining module configured to determine a slack value which is worst as a worst slack value in an instance list including the maximally appearing instance, an ECO determining module configured to determine an ECO place and ECO value based on the maximally appearing instance and the worst slack value, and a deleting module configured to delete the instance list including the maximally appearing instance.

According to one embodiment of the invention, there are provided a timing analyzing apparatus, a timing analyzing method, and a computer-readable storage medium in which the timing analyzing program is recorded, which can reduce the number of places where an ECO is issued and inserted.

The same reference numerals as in the drawings denote the same parts in the drawings.

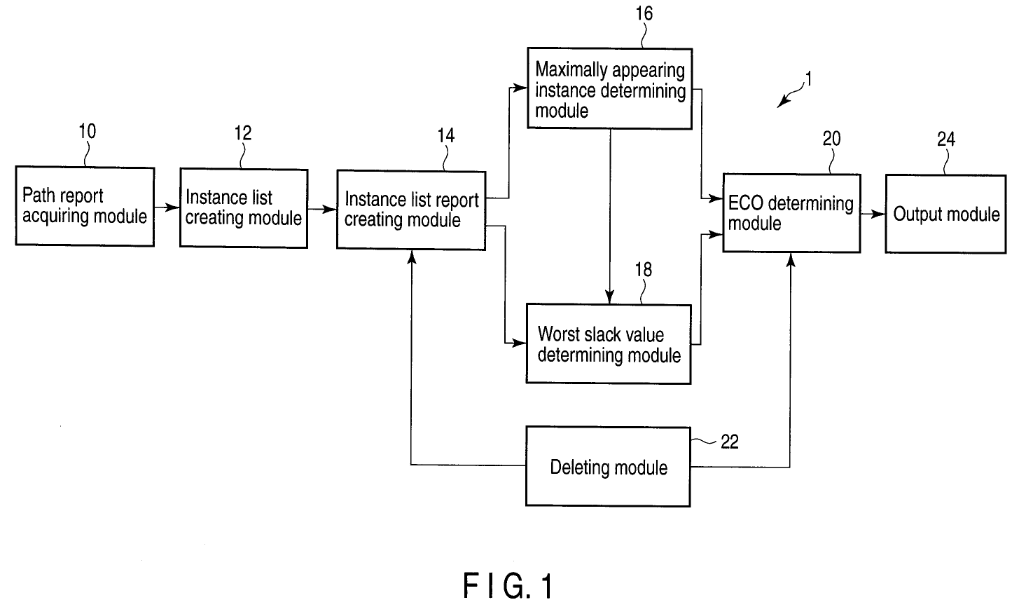

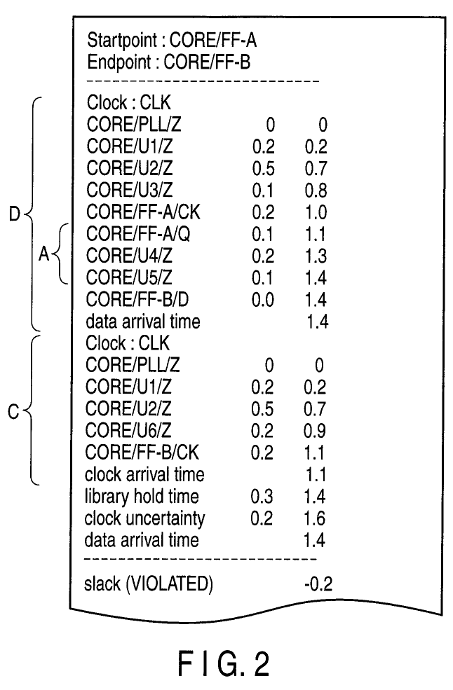

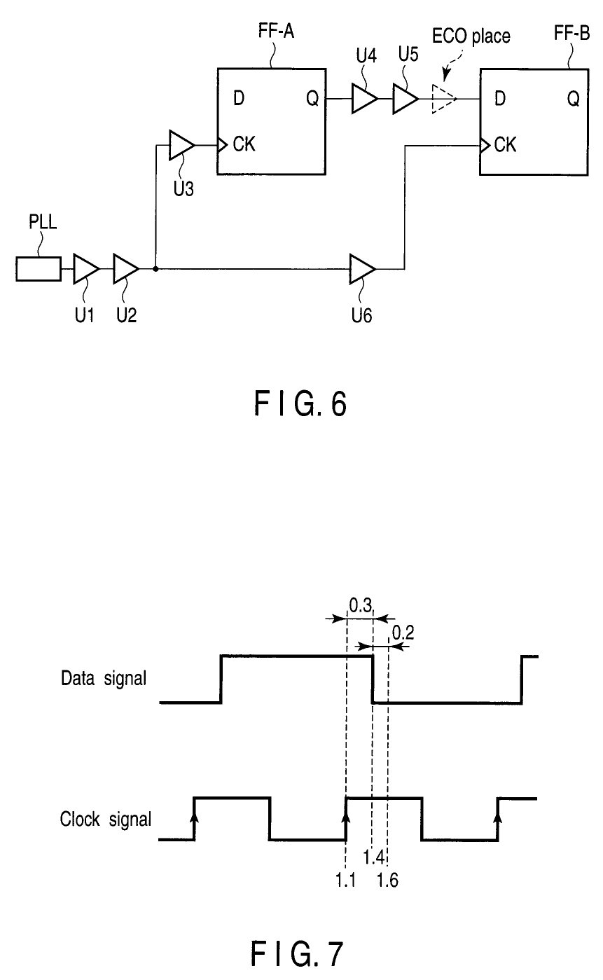

According to an embodiment, FIG. 1 shows a circuit block diagram showing a configuration of a timing analyzing apparatus, and FIGS. 2 to 5 are diagrams showing a path report, an instance list, an instance list report, and an ECO detection report, respectively. FIG. 6 is a circuit diagram of the path report shown in FIG. 2, and FIG. 7 is a timing chart between a data signal and a clock signal in the path report shown in FIG. 2.

A timing analyzing apparatus 1 shown in FIG. 1 analyzes an operation timing of an integrated circuit using an EDA environment. The timing analyzing apparatus 1 includes a path report acquiring module 10, an instance list creating module 12, an instance list report creating module 14, a maximally appearing instance determining module 16, a worst slack value determining module 18, an ECO determining module 20, a deleting module 22, and an output module 24.

The path report acquiring module 10 acquires a path report shown in FIG. 2. The path report shows timings between a start point and an end point of a clock in circuit data.

The path report shown in FIG. 2 will be described below with reference to FIGS. 6 and 7. In this path report, data signal paths between an instance FF-A and an instance FF-B and instances on clock signal paths are sequentially described from a downstream side of a flow of a signal. In association with the instances, delay times and accumulated delay times of the instances are also described.

More specifically, in a portion D of the list, instances PLL, U1, U2, U3, FF-A, U4, U5, and FF-B appearing on a data signal path of the instance FF-B starting from the PLL (Phase Locked Loop) to a data input terminal D of the instance FF-B through a clock terminal CK of the instance FF-A are described, and a total delay time of the data signal of the instance FF-B is described as data arrival time=1.4 ns. In a portion C of the list, instances PLL, U1, U2, U6, and FF-B appearing on a clock signal path of the instance FF-B starting from the PLL to the clock input signal CK of an instance FF-B are described, and a total delay time of the clock signal of the instance FF-B is described as clock arrival time=1.1 ns. Furthermore, a hold time is described as library hold time=0.3 ns, and a clock jitter is described as clock uncertainty=0.2 ns.

According to the path report, as shown in FIG. 7, in consideration of a hold time and a clock jitter, a delay time of the clock signal at the clock input terminal CK of the instance FF-B is 1.6 ns. It is understood that a hold violation for 1.4 ns−1.6 ns=−0.2 ns occurs to a delay time of 1.4 ns of the data signal at the data input terminal of the instance FF-B. Therefore, in this path report, a slack value is described as −0.2 ns.

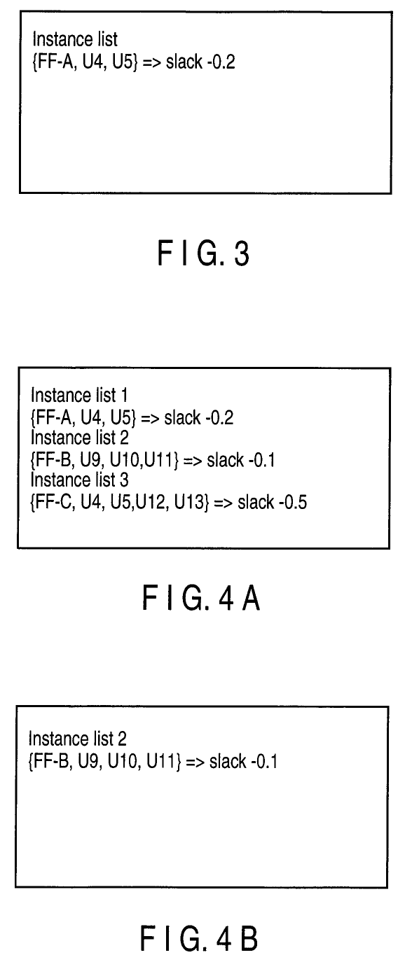

The instance list creating module 12 creates an instance list (see FIG. 3) in which instances being present between the clock input terminal CK of the instance FF-A and the data input terminal D of the instance FF-B in the path report, i.e., instances FF-A, U4, and U5 being present in a portion A are stored to be sequentially aligned from the upstream side of a flow of a signal. The instance list creating module 12 stores a slack value of −0.2 ns in the path report in an instance list in association with the instances FF-A, U4, and U5, respectively. The instance list creating module 12 performs the processes for each of the path reports formed in units of different operation modes (for example, a variation in temperature, a variation in power supply, a fluctuation in process, and the like) and analyzing modes (for example, a system mode, a scan mode, and the like) to create a plurality of instance lists.

The instance list report creating module 14 creates an instance list report (see FIG. 4A) in which a plurality of instance lists created by the instance list creating module 12 are sequentially aligned.

The maximally appearing instance determining module 16 determines, in the instance list report created by the instance list report creating module 14, an instance which most frequently appears or, if there are a plurality of instances which most frequently appear, the instance which appears at last as a maximally appearing instance.

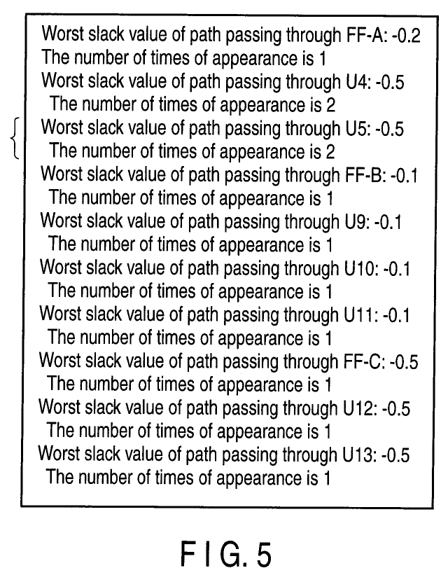

For example, as shown in FIG. 5, the maximally appearing instance determining module 16 searches the instance list report for instances sequentially from the top to increment the number of times of appearance of the instances. When the incremented number of times of appearance of the instance is larger than the maximum number of times of appearance, the maximally appearing instance determining module 16 updates the maximum number of times of appearance to the incremented number of times of appearance of the instance. Furthermore, the maximally appearing instance determining module 16 updates the instance as a maximally appearing instance.

The maximally appearing instance determining module 16 performs these processes to up to the final instance in the instance list report, and determines the maximally appearing instance which is updated at last as the maximally appearing instance. In this embodiment, the maximally appearing instance is determined as the instance U5 (the number of times of appearance is 2).

The worst slack value determining module 18 determines the worst slack value as the worst slack value in the instance list in the instance list report including the maximally appearing instance. The present embodiment is related to only a hold violation. In the embodiment, since a negative slack value expresses the hold violation, a negative slack value having the maximum absolute value serves as the worst slack value.

For example, as shown in FIG. 5, the worst slack value determining module 18 sequentially searches the instance list report for the instances from the top. When a slack value related to the instance is larger than a slack value described at present, the worst slack value determining module 18 updates the slack value described at present. When the maximally appearing instance is updated by the maximally appearing instance determining module 16, the worst slack value determining module 18 updates the worst slack value by the slack value associated with the maximally appearing instance.

The worst slack value determining module 18 performs these processes to up to the final instance, and determines the worst slack value which is updated at last as the worst slack value. In the embodiment, since the maximally appearing instance is the instance U5, the worst slack value is determined as −0.5 ns.

The ECO determining module 20 determines an ECO place and an ECO value based on the maximally appearing instance and the worst slack value. In the embodiment, the ECO determining module 20 determines an output side of the maximally appearing instance U5 as the ECO place (see FIG. 6). The ECO determining module 20 determines the worst slack value of −0.5 ns as the ECO value.

The deleting module 22 deletes instance lists 1 and 3 including the maximally appearing instance from the instance list report (see FIG. 4B).

The timing analyzing apparatus 1 repeats a loop process performed by the maximally appearing instance determining module 16, the worst slack value determining module 18, the ECO determining module 20, and the deleting module 22 until all the instance lists in the instance list report are deleted. As a result, in the embodiment, the ECO place US/ECO value 0.5 ns and ECO place U11/ECO value 0.1 ns are obtained.

The output module 24 outputs a path report such that the ECO place and the ECO value in the path report can be discriminated. For example, the output module 24 may mark an ECO target instance in the path report and additionally describe an ECO value, or may additionally describe the ECO target instance and the ECO value to the end of the path report.

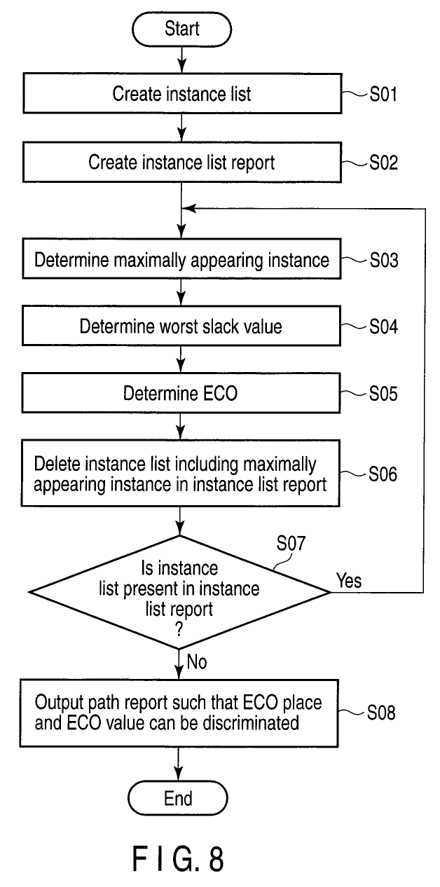

An operation of the timing analyzing apparatus according to the embodiment will be described, and a timing analyzing method according to the embodiment will be described below. FIG. 8 is a flow chart of the timing analyzing method according to the embodiment of the present invention.

The instance list creating module 12 creates an instance list (see FIG. 3) such that instances being present between the clock input terminal CK of the instance FF-A and the data input terminal D of the instance FF-B in the path report shown in FIG. 2, i.e., the instances FF-A, U4, and U5 being present at the portion A in the list are sequentially aligned from the upstream side of a flow of the signal. The instance list creating module 12 additionally stores, in the instance list, a slack value of −0.2 ns in the path report in association with the instances FF-A, U4, and U5. The instance list creating module 12 performs the processes to each of the path reports created in units of different operation modes or analyzing modes to create a plurality of instance lists (S01).

The instance list report creating module 14 creates an instance list report (see FIG. 4A) in which the plurality of instance lists created by the instance list creating module 12 are sequentially arranged (S02).

The maximally appearing instance determining module 16 determines an instance which most frequently appears in the instance list report created by the instance list report creating module 14 and which appears at last as the maximally appearing instance (S03). In the embodiment, as described above, the maximally appearing instance is determined as the instance US.

As described above, the worst slack value determining module 18 determines the worst slack value in the instance list in the instance list report including the maximally appearing instance as the worst slack value (S04). In the embodiment, as described above, the worst slack value is determined as −0.5 ns.

The ECO determining module 20 determines an ECO place and an ECO value based on the maximally appearing instance and the worst slack value. In the embodiment, the ECO determining module 20 determines an output side of the maximally appearing instance U5 as the ECO place (see FIG. 6). The ECO determining module 20 determines the worst slack value of −0.5 ns as the ECO value (S05).

In this manner, a delay of 0.5 ns or longer is inserted into the output side of the instance U5, and violation of all violation paths passing through the instance U5 is avoided.

The deleting module 22 deletes instance lists 1 and 3 including the maximally appearing instance from the instance list report (see FIG. 4B) (S06).

As a result, only an instance list which does not pass through the instance U5 and a slack value thereof are obtained.

The timing analyzing apparatus 1 determines whether an instance list is present in the instance list report (S07). When the instance list is present, the processes in the blocks S03 to S06 are performed.

On the other hand, when no instance list is present in the instance list report, the output module 24 outputs the path report such that an ECO place and an ECO value in the path report can be discriminated (S08).

In this manner, in the embodiment, ECO place U5/ECO value 0.5 ns and ECO place U11/ECO value 0.1 ns are consequently obtained.

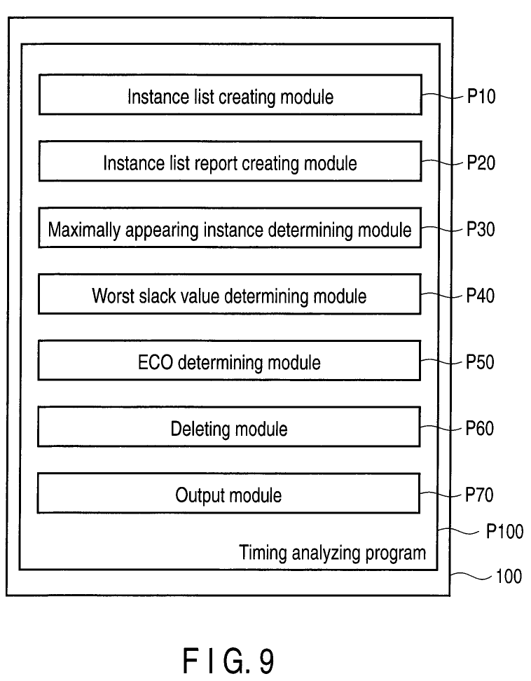

A timing analyzing program to operate a computer as the timing analyzing apparatus 1 will be described below. FIG. 9 is a diagram showing a configuration of the timing analyzing program according to the embodiment of the present invention together with a storage medium.

As shown in FIG. 9, a timing analyzing program P100 is provided while being stored in a storage medium 100. As the storage medium 100, a storage medium such as a floppy disk, a CD-ROM, a DVD, or a ROM or a semiconductor memory is exemplified.

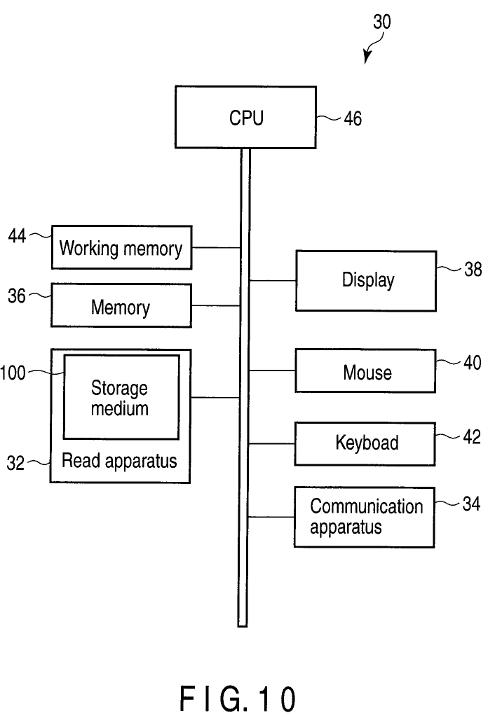

FIG. 10 is a diagram showing a hardware configuration of a computer to execute the program recorded on the storage medium.

As shown in FIG. 10, a computer 30 includes a read apparatus 32 such as a floppy disk drive apparatus, a CD-ROM drive apparatus, or a DVD drive apparatus, a working memory 44 (RAM) in which an operating system is stored, a memory 36 which stores the program stored in the storage medium 100, a display apparatus 38 such as a display, a mouse 40 and a keyboard 42 serving as input apparatuses, a communication apparatus 34 to exchange data or the like, and a CPU 46 which controls execution of the program. When the storage medium 100 is inserted into the read apparatus 32, the computer 30 can access the timing analyzing program P100 stored in the storage medium 100 from the read apparatus 32 and can operate as the timing analyzing apparatus 1 by the timing analyzing program P100.

The timing analyzing program P100 may be provided as a computer data signal superposed on a carrier wave through a network connected by the communication apparatus 44. In this case, the computer 30 stores the timing analyzing program P100 received by the communication apparatus 44 in the memory 36 to make it possible to execute the timing analyzing program P100.

As shown in FIG. 9, the timing analyzing program P100 includes an instance list creating module P10, an instance list report creating module P20, a maximally appearing instance determining module P30, a worst slack value determining module P40, an ECO determining module P50, a deleting module P60, and an output module P70. Functions realized by the computer 30 by the instance list creating module P10, the instance list report creating module P20, the maximally appearing instance determining module P30, the worst slack value determining module P40, the ECO determining module P50, the deleting module P60, and the output module P70 are the same as corresponding elements of the instance list creating module 12, the instance list report creating module 14, the maximally appearing instance determining module 16, the worst slack value determining module 18, the ECO determining module 20, the deleting module 22, and the output module 24, respectively.

In this manner, according to the timing analyzing apparatus, the timing analyzing method, and the timing analyzing program according to the embodiment and a computer-readable storage medium on which the timing analyzing program is recorded, a designer can automatically obtain an ECO place and an ECO value without checking a large number of path reports created in units of operation modes or analyzing modes one by one.

The maximally appearing instance determining module 16 determines an instance which most frequently appears as a maximally appearing instance, and the ECO determining module 20 determines an ECO place in the maximally appearing instance. For this reason, an upstream side of a signal branch point can be determined as an ECO place, and the number of ECO places can be reduced.

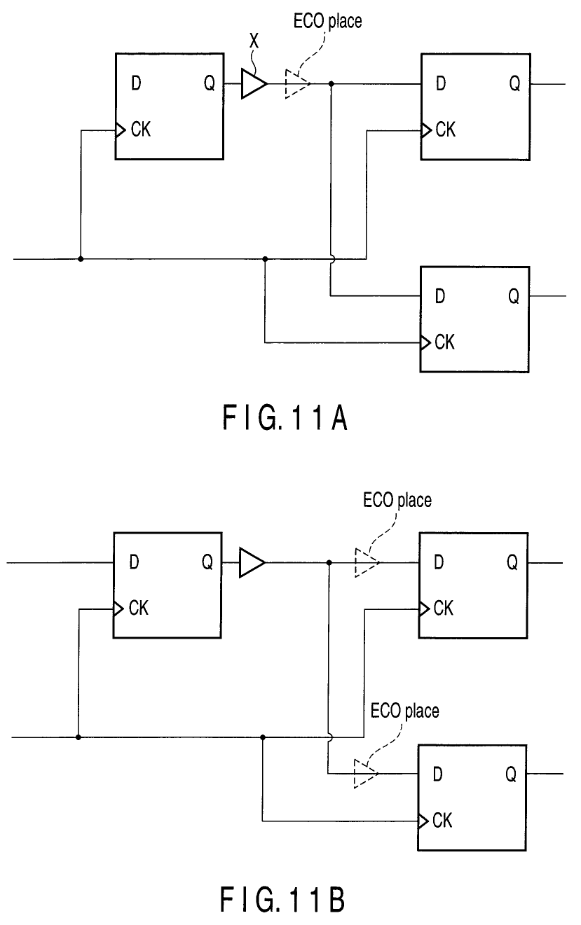

For example, in a conventional timing analyzing apparatus, importance is placed on a drive capability of an ECO-inserted instance, and as shown in FIG. 11B, an ECO place is frequently set immediately near the input side for each instance FF. As a result, as shown in FIG. 11B, when the FFs are complexly connected while being multiplexed and branched, the number of ECO places increase. However, as shown in FIG. 11A, according to the timing analyzing apparatus 1 of the embodiment, an ECO place is determined in the maximally appearing instance. For this reason, the upstream side of the signal branch point can be determined as the ECO place, and the number of ECO places can be reduced.

The maximally appearing instance determining module 16 determines an instance which appears at last as the maximally appearing instance, and the ECO determining module 20 determines the ECO place in the maximally appearing instance. For this reason, the ECO place can be determined in an instance which is on the downstream side of a flow of a signal and which is near an instance FF. Therefore, an unnecessary setup violation is not caused.

Since the ECO determining module 20 determines an output side of the maximally appearing instance as an ECO place, an upstream side of a signal branch point can be determined as an ECO place, and the number of ECO places can be reduced.

Since the output module 24 outputs the path report such that an ECO place and an ECO value in the path report can be discriminated, a designer can easily confirm the ECO place.

The various modules of the systems described herein can be implemented as software applications, hardware and/or software modules, or components on one or more computers, such as servers. While the various modules are illustrated separately, they may share some or all of the same underlying logic or code.

While a certain embodiment of the invention has been described, this embodiment has been presented by way of example only, and is not intended to limit the scope of the invention. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, in the embodiment, the output module 24 is arranged such that a designer can easily confirm an ECO place. However, the output module 24 is not necessarily arranged.

The instance list creating module 12 may weight a slack value depending on an operation mode or an analyzing mode of a path report. For example, since timing delays of an integrated circuit change depending on conditions (for example, MAX, TYPICAL, and MIN) of the operation modes, it is not proper that the magnitudes of slack values under the different conditions are compared with each other. For this reason, for example, a slack value obtained under the condition MAX is multiplied by 0.5 or the like to make it possible to perform proper comparison of magnitudes.

In the embodiment, the ECO determining module 20 determines the output side of the maximally appearing instance as the ECO place. However, when the maximally appearing instance is one input cell, the input side of the maximally appearing instance may be determined as the ECO place. In this manner, the present invention can also cope with a case in which drive capabilities of an ECO target cell and an ECO-inserted instance are considerably different from each other.

What is claimed is:

1. A timing analyzing apparatus configured to analyze an operation timing of an integrated circuit, the apparatus comprising:
an instance list creating module configured to create instance lists for each path reports, each of the instance lists being formed by aligning instances being present between logical circuits from an upstream side of a flow of a signal and storing slack values of the logical circuits;
an instance list report creating module configured to create an instance list report including the instance lists created by the instance list creating module;
a maximally appearing instance determining module configured to determine, in the instance list report, an instance which most frequently appears or, if there are a plurality of instances which most frequently appear, the instance which appears at last as a maximally appearing instance;
a worst slack value determining module configured to determine a slack value which is worst as a worst slack value in an instance list including the maximally appearing instance in the instance list report;
an engineering-change-order determining module configured to determine an engineering-change-order place and engineering-change-order value based on the maximally appearing instance and the worst slack value; and
a deleting module configured to delete the instance list including the maximally appearing instance in the instance list report, wherein
the engineering-change-order place and the engineering-change-order value in the integrated circuit are determined by a repeatedly operating the maximally appearing instance determining module, the worst slack value determining module, the engineering-change-order determining module, and the deleting module until all the instance lists in the instance list report are deleted.

2. The apparatus of claim 1, wherein
the engineering-change-order determining module determines an output side of the maximally appearing instance as the engineering-change-order place.

3. The apparatus of claim 1, wherein
the engineering-change-order determining module determines the worst slack value as the engineering-change-order value.

4. The apparatus of claim 1, wherein
the instance list creating module weights the slack value depending on an operation mode and an analyzing mode of the path report.

5. The apparatus of claim 1, further comprising:
an output module configured to output the path report such that the engineering-change-order place and the engineering-change-order value in the path report can be distinguished.

6. A timing analyzing method for analyzing an operation timing of an integrated circuit, the method comprising:
creating instance lists for each path reports, each of the instance lists being formed by aligning instances being present between logical circuits from an upstream side of a flow of a signal and storing slack values of the logical circuits;
creating an instance list report including the instance lists created by the instance list creating module;
determining, in the instance list report, an instance which most frequently appears or, if there are a plurality of instances which most frequently appear, the instance which appears at last as a maximally appearing instance;
determining a slack value which is worst as a worst slack value in an instance list including the maximally appearing instance in the instance list report;
determine an engineering-change-order place and an engineering-change-order value based on the maximally appearing instance and the worst slack value; and
deleting the instance list including the maximally appearing instance in the instance list report, wherein
the engineering-change-order place and the engineering-change-order value in the integrated circuit are determined by repeatedly operating the maximally appearing instance determining module, the worst slack value determining module, the engineering-change-order determining module, and the deleting module until all the instance lists in the instance list report are deleted.

7. A computer-readable storage medium having stored therein a timing analyzing program which analyzes an operation timing of an integrated circuit, wherein the program causes a computer to function as:
an instance list creating module configured to create instance lists for each path reports, each of the instance lists being formed by aligning instances being present between logical circuits from an upstream side of a flow of a signal and storing slack values of the logical circuits;
an instance list report creating module configured to create an instance list report including the instance lists created by the instance list creating module;
a maximally appearing instance determining module configured to determine, in the instance list report, an instance which most frequently appears or, if there are a plurality of instances which most frequently appear, the instance which appears at last as a maximally appearing instance;
a worst slack value determining module configured to determine a slack value which is worst as a worst slack value in an instance list including the maximally appearing instance in the instance list report;
an engineering-change-order determining module configured to determine an engineering-change-order place and engineering-change-order value based on the maximally appearing instance and the worst slack value; and
a deleting module configured to delete the instance list including the maximally appearing instance in the instance list report, wherein
the engineering-change-order place and the engineering-change-order value in the integrated circuit are determined by repeatedly operating the maximally appearing instance determining module, the worst slack value determining module, the engineering-change-order determining module, and the deleting module until all the instance lists in the instance list report are deleted.
